(19) United States
(12) Patent Application Publication
(10) Pub. No.: US 2026/0077366 A1
(43) Pub. Date: Mar. 19, 2026

(54) ATOMIZING METHOD

(71) Applicants: NALUX CO., LTD., Osaka (JP); TOHOKU UNIVERSITY, Sendai-shi (JP)

(72) Inventors: Shota SASAKI, Sendai-shi (JP); Toshiro KANEKO, Sendai-shi (JP); Seitaro KITAGAWA, Osaka (JP); Shinsuke KAWAI, Osaka (JP); Takashi MARUKO, Osaka (JP); Makio NISHIMAKI, Osaka (JP)

(73) Assignees: NALUX CO., LTD., Osaka (JP); TOHOKU UNIVERSITY, Sendai-shi (JP)

(21) Appl. No.: 19/396,940

(22) Filed: Nov. 21, 2025

Related U.S. Application Data
(63) Continuation of application No. PCT/JP2023/032667, filed on Sep. 7, 2023.

(51) Int. Cl. B05B 5/03

(52) U.S. Cl. CPC B05B 5/03

(57) ABSTRACT

An atomizing method using an atomizer in which peroxynitrous acid is sustainedly generated through plasma activated mist, pH of the plasma activated mist being in a range from 2 to 5, wherein the plasma activated mist has been generated from an aqueous solution containing nitrite, concentration of the nitrite being in a range from 10 micromolar to 10 milli-molar.

### CROSS REFERENCE TO RELATED APPLICATION

This is a Continuation of International Patent Application No. PCT/JP2023/032667 filed Sep. 7, 2023, which designates the U.S. The contents of this application is hereby incorporated by reference.

### TECHNICAL FIELD

The subject disclosure relates to an atomizing method of mist containing peroxynitrous acid.

### BACKGROUND ART

It is known that peroxynitrous acid has sterilizing effect. For example, patent document 1 discloses an atomizing method of mist containing peroxynitrous acid. In the atomizing method disclosed in patent document 1, a half-life of peroxynitrous acid generated is approximately 1 second (paragraphs and of WO2014145570 (A1)). In the atomizing method described above, peroxynitrous acid is generated in a plasma producer alone. Accordingly, the atomizing method disclosed in patent document 1 is not available for a wide range of applications including hand-sanitization and room sanitization. Thus, an atomizing method of mist containing peroxynitrous acid, the method being available for a wide range of applications including hand-sanitization and room sanitization, has not been developed until now.

Under the circumstances described above, there is a need for an atomizing method of mist containing peroxynitrous acid, the method being available for a wide range of applications including hand-sanitization and room sanitization. Further, it is preferable that a peak value of concentration and a half-life of concentration of peroxynitrous acid can be adapted to a variety of applications.

### PRIOR ART DOCUMENT

### Patent Document

Patent document 1: WO2014145570 (A1)

### SUMMARY

An atomizing method using an atomizer in which peroxynitrous acid is sustainedly generated through plasma activated mist, pH of the plasma activated mist being in a range from 2 to 5, wherein the plasma activated mist has been generated from an aqueous solution containing nitrite, concentration of the nitrite being in a range from 10 micromolar to 10 milli-molar.

### BRIEF DESCRIPTION OF DRAWINGS

FIG. 1 shows concentration of hydrogen peroxide, nitrous acid, nitrate ion and nitrite ion in mist generated by the plasma producer of the structure of surface DBD when an aqueous solution of sodium nitrite is used;

FIG. 2 shows pH of mist generated by the plasma producer of the structure of surface DBD when an aqueous solution of sodium nitrite is used;

FIG. 3 shows a relationship between concentration of sodium nitrite in the aqueous solution and a generation rate of peroxynitrous acid, the generation rate having been obtained by substituting values shown in FIGS. 1 and 2 into the formula (2);

FIG. 4 shows progressions over time of values of concentration of the active species, which have been obtained by the numerical simulation, when concentration of sodium nitrite in the aqueous solution is 1200 micromolar;

FIG. 5 shows progressions over time of values of concentration of the active species, which have been obtained by the numerical simulation, when concentration of sodium nitrite in the aqueous solution is 2000 micromolar;

FIG. 6 shows a progression over time of a value of concentration of peroxynitrous acid, when concentration of sodium nitrite in the aqueous solution is 1200 micromolar;

FIG. 7 show a progression over time of a value of concentration of peroxynitrous acid, when concentration of sodium nitrite in the aqueous solution is 2000 micromolar;

FIG. 8 shows a relationship between concentration of sodium nitrite in the aqueous solution and a generation rate of peroxynitrous acid when pH of plasma-activated mist is fixed at 3;

FIG. 9A shows progression over time of a value of concentration of peroxynitrous acid in the plasma-activated mist when concentration of sodium nitrite in the aqueous solution is fixed at 2000 micromolar and pH of the plasma-activated mist is changed;

FIG. 9B is an enlarged view of a portion of FIG. 9A, the portion corresponding to a range between 0 to 2 micromolar of concentration of peroxynitrous acid;

FIG. 10 is a flowchart describing how concentration of nitrite in an aqueous solution and pH of plasma-activated mist;

FIG. 11 shows an example of an atomizer used to an atomizing method according to an embodiment; and

FIG. 12 shows an example of the structure of the plasma producer.

### DESCRIPTION OF EMBODIMENTS

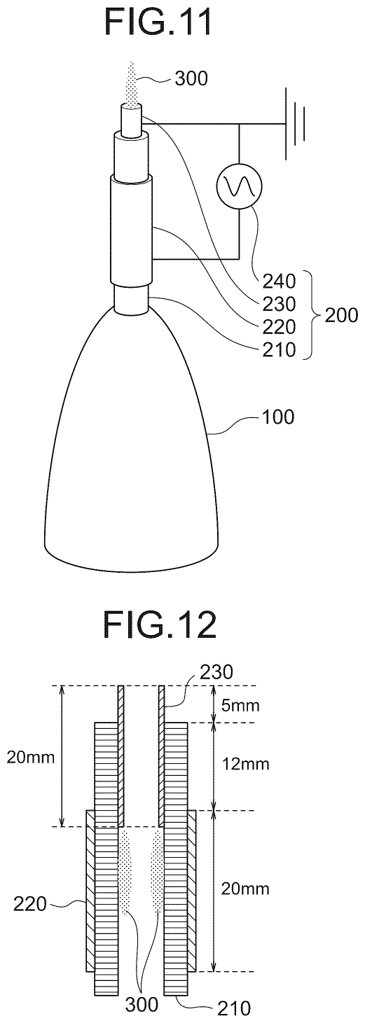

FIG. 11 shows an example of an atomizer used to an atomizing method according to an embodiment. The atomizer that produces plasma-activated mist includes a mist generator 100 and a plasma producer 200. The mist generator 100 can be a one that generates mist by an ultrasonic vibrator from liquid in a tank, the liquid consisting mainly of water. The ultrasonic vibrator is the ultrasonic nebulizer NB-80E-01-H of TDK, for example. A diameter of droplets of mist is in a range from 0.5 micrometers to 30 micrometers. The plasma producer 200 is provided with a tube 210, an external electrode 220 installed outside the tube 210, an internal electrode 230 installed inside the tube 210 and a high-frequency power source 240. Each of the external electrode 220 and the internal electrode 230 has also a tubular shape. The internal electrode 230 in the shape of a tube protrudes above the top end of the tube 210. The tube 210 is made of a dielectric. The high-frequency power source 240 is connected to the external electrode 220 and the internal electrode 230 such that a high-frequency voltage can be applied therebetween. A terminal of the high-frequency power source 240 connected to the internal electrode 230 is grounded. In general, a frequency of the high-frequency power source 240 is in a range from 1 kilohertz to 100 kilohertz. The frequency is more preferably in a range from 5 kilohertz to 30 kilohertz. A peak-to-peak value of voltage of the high-frequency power source 240 is in a range from 1 kilovolt to 30 kilovolts.

Mist generated by the mist generator 100 is sent from the bottom end of the tube 210 shown in FIG. 11 to the plasma producer 200. A flow rate of the mist is preferably in a range from 0.01 micro-litters per second (μL/s) to 1000 micro-litters per second (μL/s). When a high-frequency voltage is applied between the external electrode 220 and the internal electrode 230 by the high-frequency power source 240, the mist is plasma-activated and the plasma-activated mist 300 is delivered from the top end of the internal electrode 230 of a tubular shape, the internal electrode 230 protruding above the top end of the tube 210.

FIG. 12 shows an example of a structure of the plasma producer 200. A length in the longitudinal direction of the tube 210 is 34 millimeters. A diameter of the tube 210 is 3.9 millimeters. A wall thickness of the tube 210 is 0.7 millimeters. In general, a diameter of the tube made of dielectric is preferably in a range from 2 millimeters to 10 millimeters. In the present example, material of the tube 210 is quartz glass and the external electrode 220 installed outside the tube 210 is a conductive and adhesive tape that covers the outer surface of the tube 210. The tape is made of copper-foil. A width (a length in the longitudinal direction of the tube 210) of the copper-foil tape is 20 millimeters and a thickness of the copper-foil tape is 0.7 millimeters. The top end of the external electrode 220 is located 12 millimeters below the top end of the tube 210. In the present example, the internal electrode 230 installed inside the tube 210 is a tube made of stainless steel. A length in the longitudinal direction of the tube made of stainless steel is 20 millimeters. An outside diameter of the tube made of stainless steel is 2.41 millimeters and a wall thickness of the tube made of stainless steel is 0.21 millimeters. A length in the longitudinal direction of an overlapping area of the external electrode 220 and the internal electrode 230 is 3 millimeters. The internal electrode 230 protrudes above the top end of the tube 210 and a length in the longitudinal direction of a portion of the internal electrode 230, the portion being above the top end of the tube 210, is 5 millimeters. In the present example, the plasma-activated mist 300 is formed on and near an area of the inner surface of the tube 210, the area being below and adjacent to the bottom end of the internal electrode 230 and surrounded by the external electrode 220.

In general, both of the electrodes are located such that a position of the external electrode and a position of the internal electrode in in the longitudinal direction of the tube 210 are not identical with each other. In order that electrical discharge between both of the electrodes can easily occur, it is preferable to locate both of the electrodes such that they partially overlap with each other in in the longitudinal direction of the tube 210.

The structure of the plasma producer 200 shown in FIG. 12 is referred to as a structure of surface dielectric barrier discharge (a structure of surface DBD).

It is known that peroxynitrous acid (HOONO) has sterilizing effect. Conventionally in the field of plasma engineering, it has been generally considered that peroxynitrous acid is generated in a “plasma producer” and has a half-life of around one second (for example, in the paragraph and paragraph of patent document 1). The inventors of the present application have focused on a possibility that peroxynitrous acid is generated not only in the plasma producer but also from active species in plasma activated mist and have analyzed the process of generation of peroxynitrous acid. As a result, it has been found that nitrous acid from which peroxynitrous acid is generated tends to be exhausted in plasma activated mist and it has been decided to use an aqueous solution of nitrite for generation of mist.

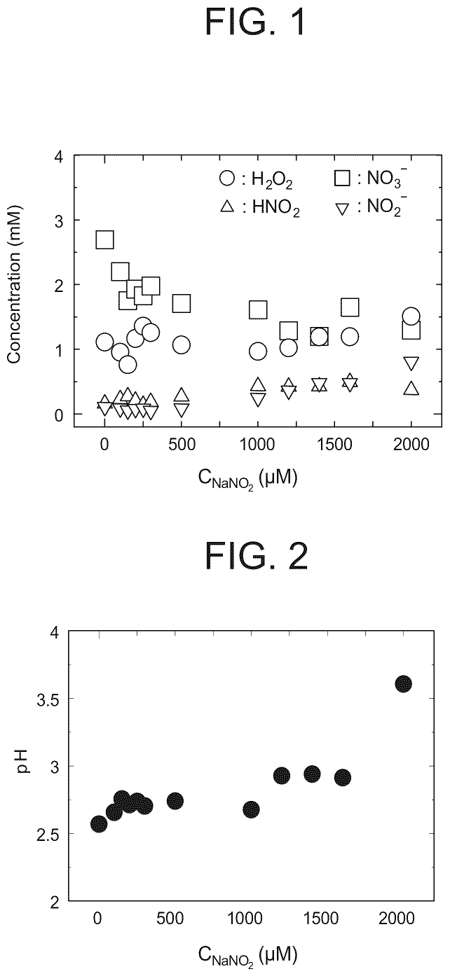

FIG. 1 shows concentration of hydrogen peroxide, nitrous acid, nitrate ion and nitrite ion in mist generated by the plasma producer of the structure of surface DBD when an aqueous solution of sodium nitrite is used. The horizontal axis of FIG. 1 indicates concentration of sodium nitrite in the aqueous solution. The unit of concentration is micromolar. The vertical axis of FIG. 1 indicates concentration of active species in the mist. The unit of concentration is millimolar. A peak-to-peak value of voltage between both electrodes is 16.3 kilovolts.

Values of concentration of the active species were obtained through measurement of droplets collected from the mist by means of a glass plate or the like, the measurement being carried out by absorptiometry using ultramicrocells.

FIG. 2 shows pH of mist generated by the plasma producer of the structure of surface DBD when an aqueous solution of sodium nitrite is used. The horizontal axis of FIG. 2 indicates concentration of sodium nitrite in the aqueous solution. The unit of concentration is micromolar. The vertical axis of FIG. 2 indicates pH of the mist.

According to findings of the inventors, peroxynitrous acid is generated from hydrogen peroxide and nitrous acid in mist in accordance with the following formula.

$${H}_{2} {O}_{2} + {HNO}_{2} + {H}^{+} \to HOONO + {H}_{2} O + {H}^{+} \qquad ( 1 )$$

A generation rate of peroxynitrous acid can be expressed by the following formula (2).

$${r}_{HOONO} = k [ {H}_{2} {O}_{2} ] [ {HNO}_{2} ] [ {H}^{+} ] ≅ k [ {H}_{2} {O}_{2} ] [ {HNO}_{2} ] [ {NO}_{3}^{-} ] \qquad ( 2 )$$

k represents a reaction rate constant and the following value was employed.

$$k = 9.6 \times {10}^{3} ( {M}^{- 2} {s}^{- 1} )$$

By substituting values of concentration of active species, which have been obtained by the above-described measuring method, and a value of concentration of hydrogen ion, which have been calculated from the value of pH, into the formula (2), the generation rate of peroxynitrous acid can be obtained. When concentration of nitric acid is greater than concentration of nitrous acid and no pH buffer agent is contained, the value of concentration of hydrogen ion can be estimated from a value of concentration of nitrate ion.

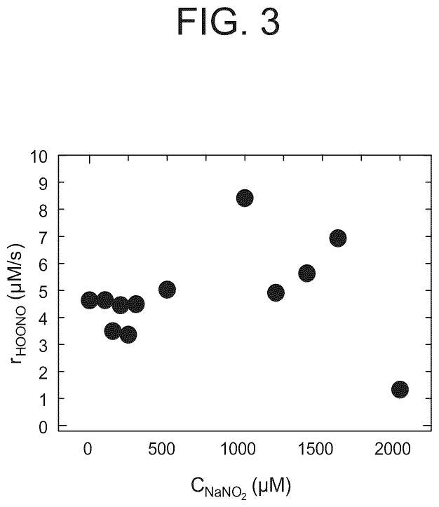

FIG. 3 shows a relationship between concentration of sodium nitrite in the aqueous solution and a generation rate of peroxynitrous acid, the generation rate having been obtained by substituting values shown in FIGS. 1 and 2 into the formula (2). The horizontal axis of FIG. 3 indicates concentration of sodium nitrite in the aqueous solution. The unit of concentration is micromolar. The vertical axis of FIG. 2 indicates a generation rate of peroxynitrous acid. The unit of a generation rate of peroxynitrous acid is micromolar per second (μM/s). It is estimated that concentration and sterilizing effect of peroxynitrous acid are closely related to a generation rate of peroxynitrous acid.

The inventors have then hit upon an idea of estimating progressions over time of values of concentration of the active species and peroxynitrous acid through a numerical simulation method. In the numerical simulation method, a zeroth-order chemical reaction model in which a spatial distribution is not considered was used and the progressions over time of values of concentration of the active species and peroxynitrous acid were obtained by implicitly resolving ordinary differential equations expressing plural nonequilibrium chemical reaction formulars and equilibrium chemical reaction formulars that are concerned with the reactions. The nonequilibrium chemical reaction formulars and the equilibrium chemical reaction formulars that were used in the numerical simulation method is shown in Table 1. As initial values in the numerical simulation method were used the data shown in FIG. 1 and FIG. 2.

TABLE 1

| Reaction | Reaction |
|---|---|
| H₂O₂ + OH → H₂O + O₂⁻ | NO₂⁺ + H₂O → NO₃⁻ + H⁺ + H⁺ |
| HO₂ + H₂O₂ → O₂ + | NO₂⁺ H₂O₂ → HO₂NO₂ + H⁺ |
| H₂O + OH | |
| O₂⁻ + H₂O₂ → O₂ + H₂O + OH | N₂O₃ + H₂O → NO₂⁻ + NO₂⁻ + H⁺ |
| H₂O₂ + HNO₂ + H⁺ → | N₂O₃ → NO₂ + NO |
| HO₂NO + H₂O + H⁺ | |
| OH + HO₂ → O₂ + H₂O | N₂O₃ + ONO₂⁻ → NO₂ + |
| | NO₂ + NO₂⁻ |
| OH + O₂⁻ → O₂ + OH⁻ | N₂O₄ + H₂O → NO₂⁻ + NO₃⁻ + |
| | H⁺ + H⁺ |
| OH + OH → H₂O₂ | ONO₂⁻ → NO + O₂⁻ |
| OH + NO → NO₂⁻ + H⁺ | HO₂NO → OH + NO₂ |
| OH + NO₂ → HO₂NO | HO₂NO → NO₃⁻ + H⁺ |
| OH + NO₂⁻ → NO₂ + OH⁻ | HO₂NO + H₂O + H⁺ → HNO₂ + |
| | NO₂ + H₂O₂ + H⁺ |
| OH + HNO₃ → products | HO₂NO + H⁺ → NO₂⁺ + H₂O |
| OH + ONO₂⁻ → NO + O₂ + OH⁻ | HNO₂ + HO₂NO + H⁺ → NO₂ + |
| | NO₂ + H₂O + H⁺ |
| HO₂ + HO₂ → O₂ + H₂O₂ | O₂NO₂⁻ → NO₂⁻ + O₂ |
| H₂O + HO₂ + O₂⁻ → O₂ + | O₂NO₂⁻ → NO₂ + O₂⁻ |
| H₂O₂ + OH⁻ | |
| HO₂ + NO → HO₂NO | HO₂NO₂→ NO₂ + HO₂ |
| HO₂ + NO₂ → HO₂NO₂ | HO₂NO₂ + HNO₂→ NO₃⁻ + |
| | NO₃⁻ + H⁺ + H⁺ |
| O₂⁻ + NO → ONO₂⁻ | HNO₂ + HNO₂→ NO₂ + |
| | NO + H₂O |
| O₂⁻ + NO₂ → O₂NO₂⁻ | HNO₃ = H⁺ + NO₃⁻ |
| O₂⁻ + NO₂ → O₂ + NO₂⁻ | H₂O = H⁺ + OH⁻ |
| NO₂ + NO → N₂O₃ | HNO₂ = H⁺ + NO₂⁻ |
| O₂ + NO + NO → NO₂ + NO₂ | HO₂ = H⁺ + O₂⁻ |
| H₂O + NO₂ + NO₂ → NO₂⁻ + | HO₂NO = H⁺ + ONO₂⁻ |
| NO₃⁻ + H⁺ + H⁺ + H₂O | |
| NO₂ + NO₂ → N₂O₄ | HO₂NO₂ = H⁺ + O₂NO₂⁻ |

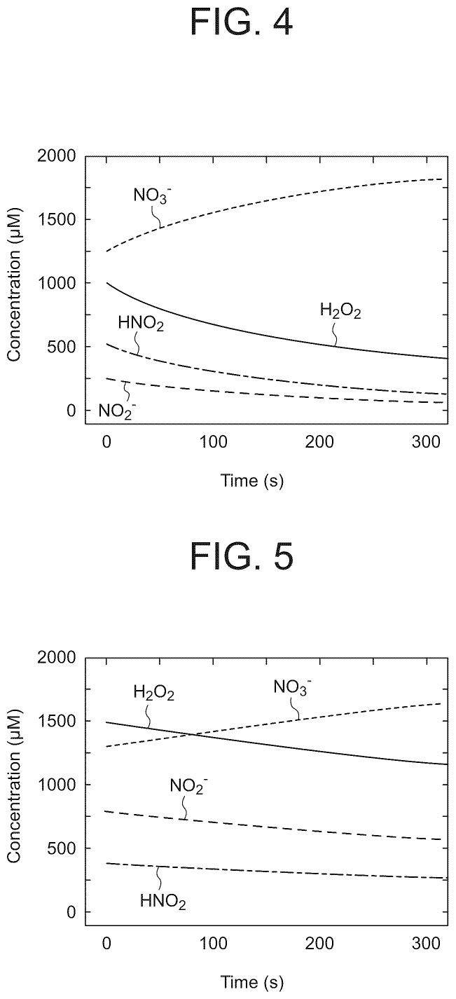

FIG. 4 shows progressions over time of values of concentration of the active species, which have been obtained by the numerical simulation, when concentration of sodium nitrite in the aqueous solution is 1200 micromolar. The horizontal axis of FIG. 4 indicates time. The unit of time is second. The vertical axis of FIG. 4 indicates concentration of the active specie. The unit of concentration is micromolar. As initial values of concentration of the active specie in mist, the data shown in FIG. 1 were used and as the value of pH of the mist, the data shown in FIG. 2 were used.

FIG. 5 shows progressions over time of values of concentration of the active species, which have been obtained by the numerical simulation, when concentration of sodium nitrite in the aqueous solution is 2000 micromolar. The horizontal axis of FIG. 5 indicates time. The unit of time is second. The vertical axis of FIG. 5 indicates concentration of the active specie. The unit of concentration is micromolar. As initial values of concentration of the active specie in mist, the data shown in FIG. 1 were used and as the value of pH of the mist, the data shown in FIG. 2 were used.

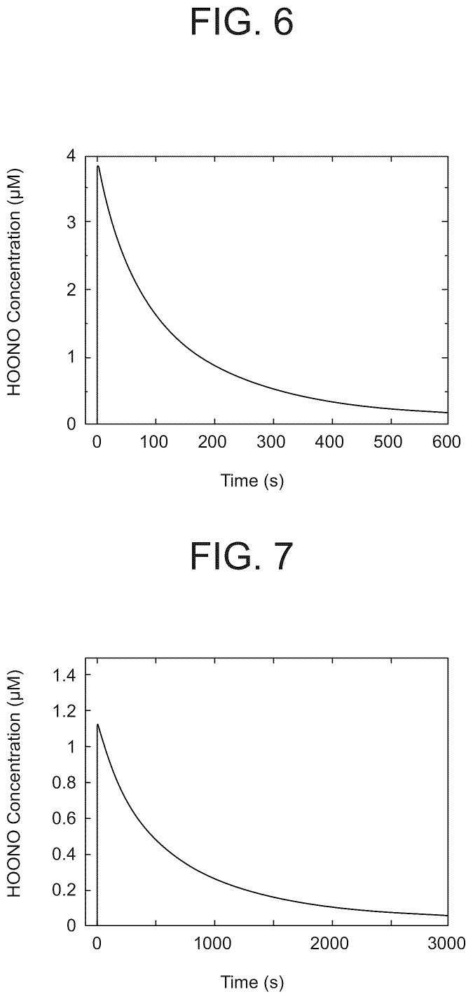

FIG. 6 shows progression over time of a value of concentration of peroxynitrous acid, when concentration of sodium nitrite in the aqueous solution is 1200 micromolar. The progression over time of a value of concentration of peroxynitrous acid was obtained by the numerical simulation,

FIG. 7 show a progression over time of a value of concentration of peroxynitrous acid, when concentration of sodium nitrite in the aqueous solution is 2000 micromolar. The progression over time of a value of concentration of peroxynitrous acid was obtained by the numerical simulation,

Influence of concentration of sodium nitrite in the aqueous solution on a generation rate of peroxynitrous acid will be analyzed below. According to FIG. 1, the total amount of nitrous acid ([NO2-]+[HNO2]) in the activated mist increases with increase in concentration of sodium nitrite in the aqueous solution. A ratio of an amount of nitrous acid to an amount of nitrite ion ([HNO2]/[NO2-]) decreases with increase in concentration of sodium nitrite in the aqueous solution. On the other hand, according to FIG. 2, pH increases with increase in concentration of sodium nitrite in the aqueous solution. In other words, hydrogen ion (H+) decreases with increase in concentration of sodium nitrite in the aqueous solution. According to the formula (2), a generation rate of peroxynitrous acid increases with increase in the total amount of nitrous acid. On the other hand, the generation rate of peroxynitrous acid decreases with decease in hydrogen ion and decease in the ratio of an amount of nitrous acid to an amount of nitrite ion. Accordingly, as shown in FIG. 3, the generation rate of peroxynitrous acid increases with increase in concentration of sodium nitrite in the aqueous solution, reaches a maximum value at approximately 1 millimolar and then decreases with increase in concentration of sodium nitrite in the aqueous solution.

Considering the above-described results, which have been obtained through numerical simulation, in which measured values such as those of active species in the activated mist have been used, the inventors have hit upon an idea of adjusting a generation rate of peroxynitrous acid by pH of the activated mist.

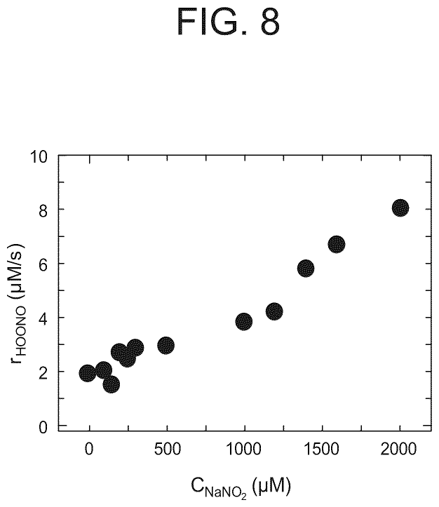

FIG. 8 shows a relationship between concentration of sodium nitrite in the aqueous solution and a generation rate of peroxynitrous acid when pH of plasma-activated mist is fixed at 3. The horizontal axis of FIG. 8 indicates concentration of sodium nitrite in the aqueous solution. The unit of concentration is micromolar. The vertical axis of FIG. 8 indicates a generation rate of peroxynitrous acid. The unit of a generation rate is micromolar per second (μM/s). The generation rate of peroxynitrous acid was obtained from the formula (2) using the data shown in FIG. 1. According to FIG. 8, a generation rate of peroxynitrous acid increases with increase in concentration of sodium nitrite in the aqueous solution. In this manner, a generation rate of peroxynitrous acid increases with increase in concentration of sodium nitrite in the aqueous solution when pH of the plasma-activated mist is determined according to the concentration of the aqueous solution by adding a sufficient amount of pH buffer agent to the aqueous solution in advance.

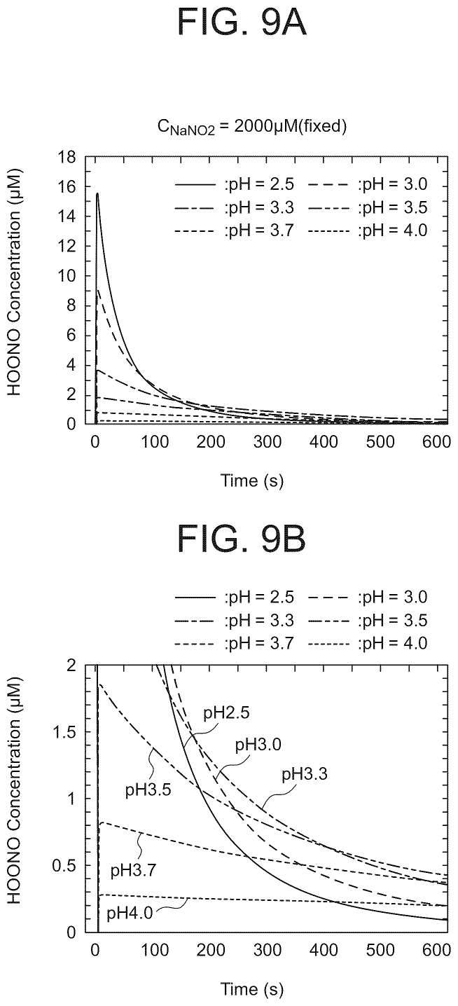

FIG. 9A shows progressions over time of values of concentration of peroxynitrous acid in the plasma-activated mist when concentration of sodium nitrite in the aqueous solution is fixed at 2000 micromolar and pH of the plasma-activated mist is changed. The horizontal axis of FIG. 9A indicates time. The unit of time is second. The vertical axis of FIG. 9A indicates concentration of peroxynitrous acid in the mist. The unit of concentration is micromolar. The progressions over time of values of concentration of peroxynitrous acid were obtained through the numerical simulation described above using the data shown in FIG. 1.

FIG. 9B is an enlarged view of a portion of FIG. 9A, the portion corresponding to a range between 0 to 2 micromolar of concentration of peroxynitrous acid.

According to FIG. 9A and FIG. 9B, when pH is changed from 2.5 to 4, a peak value of concentration of peroxynitrous acid in the mist decreases from 15.8 micromolar to 0.28 micromolar and a half-life of concentration of peroxynitrous acid in the mist increases from approximately 30 seconds to approximately 1600 seconds. In this way, when concentration of nitrous acid in the aqueous solution is kept at a constant value, a peak value of concentration of peroxynitrous acid and a half-life of concentration of peroxynitrous acid changes depending on pH of the plasma-activated mist.

The inventors analyzed a relationship between concentration of sodium nitrite in the aqueous solution and a generation rate of peroxynitrous acid when pH of plasma-activated mist is fixed at 3, the relationship being shown in FIG. 8, and progressions over time of values of concentration of peroxynitrous acid in the plasma-activated mist when concentration of sodium nitrite in the aqueous solution is fixed at 2000 micromolar and pH of the plasma-activated mist is changed, the progressions over time of values of concentration of peroxynitrous acid in the plasma-activated mist being shown in FIG. 9A, and then the inventors have hit on an idea of changing a manner in which a value of concentration of peroxynitrous acid in the plasma-activated mist progresses over time, by adjusting concentration of sodium nitrite in the aqueous solution and pH of the plasma-activated mist. When atomization is carried out for sterilization, a peak value and a half-life of concentration of peroxynitrous acid are important parameters. For example, a way of atomization in which a peak value of concentration is relatively great and a half-life of concentration is relatively small as shown in FIG. 6 is suitable for use of hand-sanitizing. On the other hand, a way of atomization in which a peak value of concentration is relatively small and a half-life of concentration is relatively great as shown in FIG. 7 is suitable for use of atomization in a room.

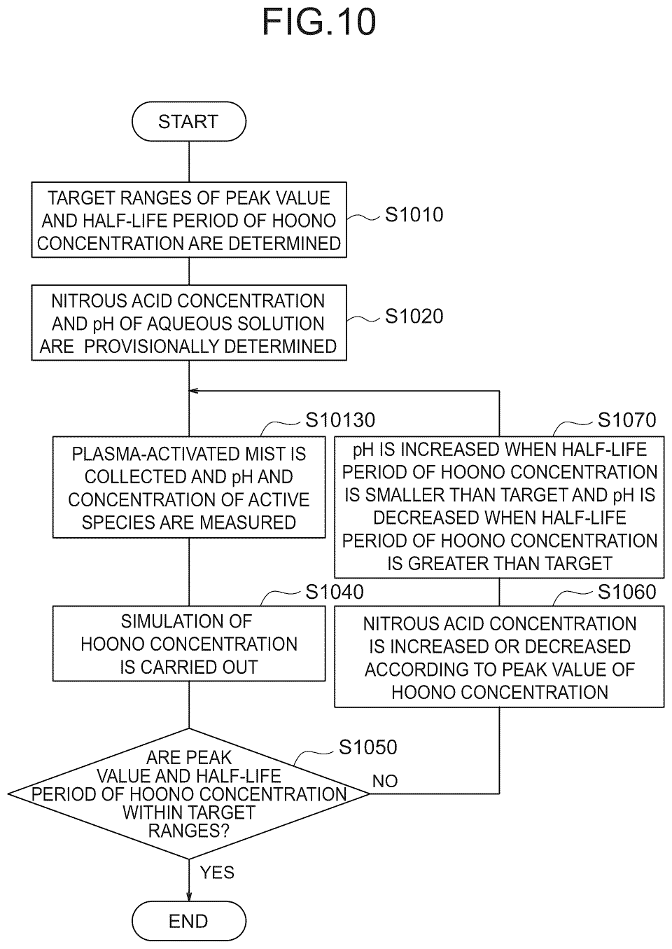

FIG. 10 is a flowchart describing how to determine concentration of nitrite in an aqueous solution and pH of plasma-activated mist.

In step S1010 of FIG. 10, a target range of a peak value and a target range of a half-life of concentration of peroxynitrous acid are determined.

In step S1020 of FIG. 10, concentration of nitrous acid and pH of an aqueous solution are provisionally determined. Concentration of nitrous acid of the aqueous solution is in a range from 10 micromolar to 10 milli-molar.

In step S1030 of FIG. 10, atomization is carried out by an atomizer using an aqueous solution, concentration of nitrous acid and pH of which have been determined in step S1020, droplets of generated mist are collected and concentration of hydrogen peroxide, nitrate ion, nitrous acid and nitrite ion and pH are measured. Measurement of the droplets, which have been collected from the mist by means of a glass plate or the like, is carried out by absorptiometry using ultramicrocells.

In step S1040 of FIG. 10, numerical simulation of is carried out using measured values that have been obtained in step S1030 as initial values to obtain such progressions over time of values of concentration of peroxynitrous acid as shown in FIG. 9A.

In step S1050 of FIG. 10, it is determined whether each of a peak value and a half-life of concentration of peroxynitrous acid is within a corresponding target range or not. If each of the two values is within a corresponding target range, the process is terminated. If at least one of the two values is not within a corresponding target range, the process goes to step S1060.

In step S1060 of FIG. 10, concentration of nitrous acid is increased or decreased according to the peak value of concentration of peroxynitrous acid.

In step S1070 of FIG. 10, pH is increased when the half-life of concentration of peroxynitrous acid is smaller than the corresponding target value and pH is decreased when the half-life of concentration of peroxynitrous acid is greater than the corresponding target value. Then the process goes to step S1030. As described above, pH of the plasma-activated mist can be determined according to pH of the aqueous solution by adding a sufficient amount of pH buffer agent to the aqueous solution.

As nitrite, sodium nitrite that is low-priced and suitable for use with human beings and animals and potassium nitrite that is suitable for use with vegetation are preferable, but nitrite of all kinds of cation is available. As a method to prepare nitrous acid, nitrogen monoxide, nitrogen dioxide, dinitrogen trioxide and dinitrogen tetra-oxide gasses can be solved into a solute in advance.

For regulation of pH of an aqueous solution, a pH regulator is used. A pH regulator is an acid, a base or a combination of an acid or a base and a pH buffer agent. The acid is nitric acid, hydrochloric acid or the like. The base is sodium hydroxide, potassium hydroxide, calcium hydroxide, ammonia or the like. The pH buffer agent is citric acid, succinic acid, acetic acid, oxalic acid, phosphoric acid, carbonic acid or the like.

By the use of a pH regulator, concentration of nitrite in an aqueous solution and pH of a plasma-activated mist can be regulated independently of each other.

When concentration of active species that have existed for a certain period of time after having been activated is measured at a position, for example, 5 centimeters away from the spraying nozzle of an atomizer, measured values are substantially identical with the data that are shown in FIG. 4 and FIG. 5, the data having been obtained through the numerical simulation. This fact shows that peroxynitrous acid is sustainedly generated in the present method. When measurement of active species that have been generated in a conventional atomizing method such as that shown in patent document 1 is carried out in a way similar to the above-described one, measured values that show a satisfactory generation rate of peroxynitrous acid cannot be obtained. Thus, in a conventional atomizing method, peroxynitrous acid is not sustainedly generated through mist delivered from a plasma producer of an atomizer.

An atomizing method of mist containing peroxynitrous acid, the method being available for a wide range of applications including hand-sanitization and room sanitization and the method making it possible to adapt a peak value of concentration and a half-life of concentration of peroxynitrous acid to a variety of applications, is provided.

In an atomizing method using an atomizer according to an embodiment, peroxynitrous acid is sustainedly generated through plasma activated mist, pH of the plasma activated mist being in a range from 2 to 5, wherein the plasma activated mist has been generated from an aqueous solution containing nitrite concentration of which is in a range from 10 micromolar to 10 milli-molar.

In the atomizing method, a peak value of concentration and a half-life of concentration of peroxynitrous acid contained in plasma-activated mist can be adjusted by changing concentration of nitrite in the aqueous solution that is used to generate the plasma-activated mist for atomization and pH of the plasma-activated mist.

In an atomizing method using an atomizer according to another embodiment, a pH regulator is added to the aqueous solution.

In an atomizing method using an atomizer according to a still another embodiment, pH of the plasma activated mist is made identical with pH of the aqueous solution by adding a sufficient amount of a pH buffer agent to the aqueous solution.

When the aqueous solution contains no pH buffer agent, pH greatly changes through plasma activation. On the other hand, when the aqueous solution contains a sufficient amount of a pH buffer agent, an amount of a change in pH through plasma activation is negligible and pH of the plasma activated mist is made identical with pH of the aqueous solution. Accordingly, pH of the plasma activated mist can be determined by pH of the aqueous solution.

In an atomizing method using an atomizer according to a still another embodiment, pH of the aqueous solution is regulated by adding acid or base to the aqueous solution and pH of the activated mist is made identical with pH of the aqueous solution by adding a sufficient amount of a pH buffer agent to the aqueous solution.

According to the present embodiment, pH of the activated mist can be determined by pH of the aqueous solution, the pH of the aqueous solution having been regulated by adding acid or base to the aqueous solution.

In an atomizing method using an atomizer according to a still another embodiment, a progression over time of a value of concentration of peroxynitrous acid in the mist generated by the atomizer is estimated through numerical simulation based on measured values of concentration of active species and pH of the mist that has been generated by the atomizer.

According to the present embodiment, through numerical simulation based on measured values of concentration of active species and pH of the mist that has been generated by the atomizer, a peak value of concentration and a half-life of concentration of peroxynitrous acid contained in the mist can be estimated.

In an atomizing method using an atomizer according to a still another embodiment, concentration of nitrite in the aqueous solution is in a range from 100 micromolar to 1600 micromolar and pH of the aqueous solution is in a range from 2.5 to 3.

In an atomizing method using an atomizer according to a still another embodiment, the atomizer is provided with a plasma producer of a structure of surface DBD.

What is claimed is:

1. An atomizing method using an atomizer in which peroxynitrous acid is sustainedly generated through plasma activated mist, pH of the plasma activated mist being in a range from 2 to 5, wherein the plasma activated mist has been generated from an aqueous solution containing nitrite, concentration of the nitrite being in a range from 10 micromolar to 10 milli-molar.

2. The atomizing method according to claim 1, wherein a pH regulator is added to the aqueous solution.

3. The atomizing method according to claim 1, wherein pH of the plasma activated mist is made identical with pH of the aqueous solution by adding a sufficient amount of a pH buffer agent to the aqueous solution.

4. The atomizing method according to claim 1, wherein pH of the aqueous solution is regulated by adding acid or base to the aqueous solution and pH of the activated mist is made identical with pH of the aqueous solution by adding a sufficient amount of a pH buffer agent to the aqueous solution.

5. The atomizing method according to claim 1, wherein a progression over time of a value of concentration of peroxynitrous acid in the mist generated by the atomizer is estimated through numerical simulation based on measured values of concentration of active species and pH of the mist that has been generated by the atomizer.

6. The atomizing method according to claim 1, wherein concentration of nitrite in the aqueous solution is in a range from 100 micromolar to 1600 micromolar and pH of the aqueous solution is in a range from 2.5 to 3.

7. The atomizing method according to claim 1, wherein the atomizer is provided with a plasma producer of a structure of surface DBD.
